(19) United States
(12) Patent Application Publication
(10) Pub. No.: US 2026/0089788 A1
(43) Pub. Date: Mar. 26, 2026

(54) WIRELESSLY CONTROLLABLE HOIST SYSTEM WITH LOST REMOTE AVOIDANCE

(71) Applicant: Liko Research & Development AB, Luleå (SE)

(72) Inventors: Ronan Appriou, Pluvigner (FR); Francois Wibaux, Auray (FR); Mickael Audic, Locmiquélic (FR); Maxime Emile Scolan, Pluvigner (FR)

(73) Assignee: Liko Research & Development AB, Luleå (SE)

(21) Appl. No.: 19/340,143

(22) Filed: Sep. 25, 2025

Related U.S. Application Data
(60) Provisional application No. 63/699,343, filed on Sep. 26, 2024.

(51) Int. Cl. H04W 76/18; G08B 21/18; H04W 4/80; H04W 76/19

(52) U.S. Cl. CPC H04W 76/18; G08B 21/182; H04W 4/80; H04W 76/19

(57) ABSTRACT

A wirelessly controllable hoist system is disclosed. The system includes a hoist assembly that includes a hoist wireless transceiver configured for personal area network communications, and a remote control unit to control the hoist assembly. The remote control unit includes a remote wireless transceiver that communicates with the hoist wireless transceiver via a personal area network. The remote control unit further includes an audio, a haptic, and/or a visual indication component that is affixed to a housing of the remote control unit, and which generate a respective audible or visible alarm. The remote control unit further includes a processor in communication with the remote wireless transceiver and memory storing instructions which are executed to perform at least one connection attempt to establish bi-directional communication with the hoist assembly, and in response to a failed connection attempt, generate the alarm via the audio, the haptic, or the visual indication component.

### CROSS REFERENCE TO RELATED APPLICATIONS

This application claims benefit to U.S. Provisional Application Ser. No. 63/699,343 filed Sep. 26, 2024.

### TECHNICAL FIELD

The present specification generally relates to hoists for transporting and assisting subjects with compromised mobility, and, more specifically, to a wireless remote-controlled hoist.

### BACKGROUND

Overhead or mobile hoists, particularly in medical care facilities such as hospitals, rehabilitation centers, nursing homes, and other care facilities, are generally controlled by either a corded controller or a wall-mounted controller. The wall-mounted controller may be wirelessly or directly connected (e.g., wired) to the overhead hoist. The fixed nature of the controller, e.g., corded or wall-mounted, is intended, for example, to prevent the loss of the controller by a caregiver inadvertently taking the controller from the room.

However, the corded controller presents numerous difficulties in use. A caregiver must move the corded controller around obstacles, untangle the controller when necessary, avoid contacting the subject, as well as ensure that the controller remains at an accessible location for subsequent caregivers, e.g., height. The wall-mounted controller also presents challenges, albeit different from the corded controller. For example, the controller is typically mounted on a wall some distance away from the hoist. This results in the caregiver being kept at a distance from the subject, unable to effectuate any assistance should the subject be unable to grasp the hoist. Further, in some instances, the caregiver may have to turn away from the subject view the wall-mounted controller to identify and/or activate the necessary controls, e.g., raise, lower, move in the x and/or y directions, etc. Such emplacement on the wall may prevent the caregiver from identifying any issues relative to the subject and position of the hoist on ceiling.

### SUMMARY

According to at least one aspect of the present disclosure, a wirelessly controllable hoist system is disclosed. The wirelessly controllable hoist system includes a hoist assembly that includes a hoist wireless transceiver configured for personal area network communications. The system further includes a remote control unit that is operable to control the hoist assembly. The remote control unit includes a remote wireless transceiver that is configured to communicate with the hoist wireless transceiver of the hoist assembly via a personal area network. The remote control unit further includes one or more of an audio, a haptic, or a visual indication component that is affixed to a housing of the remote control unit, and which are configured to generate a respective audible or visible alarm. The remote control unit further includes a processor that is in communication with the remote wireless transceiver and memory storing instructions which are executed by the processor to perform at least one connection attempt to establish bi-directional communication with the hoist assembly, and in response to a failed connection attempt, generate the alarm via the at least one of the audio, the haptic, or the visual indication component.

According to at least one aspect of the present disclosure, a remote control unit of a hoist system is disclosed. The remote control unit includes a remote wireless transceiver that is configured for communication with a wireless transceiver of an associated hoist assembly via a personal area network. The remote control unit also includes one or more of an audio, a haptic, or a visual indication component that are affixed to a housing of the remote control unit, and which are operable to generate a respective audible or visible alarm. The remote control unit further includes a processor that is in communication with the remote wireless transceiver and memory storing instructions which are executed by the processor to initiate a connection timer corresponding to a time period during which a connection attempt is made, and perform at least one connection attempt to establish bi-directional communication with the hoist assembly during the time period. The instructions stored in memory also are executed by the processor to, in response to a preset number of failed connection attempts, generate the alarm via the audio, the haptic, and/or the visual indication component.

According to at least one aspect of the present disclosure, a remote control unit of a hoist system is disclosed. The remote control unit includes a remote wireless transceiver that is configured for communication with a wireless transceiver of an associated hoist assembly via a personal area network. The remote control unit also includes one or more of an audio, a haptic, or a visual indication component that is affixed to a housing of the remote control unit, and which are operable to generate a respective audible or visible alarm. The remote control unit further includes a processor in communication with the remote wireless transceiver and memory storing instructions which are executed by the processor to initiate a connection timer corresponding to a time period during which a connection attempt is made, and perform the connection attempt to establish bi-directional communication with the hoist assembly during the time period. The remote control unit also includes instructions to increment a retry counter in response to a failed connection attempt occurring during the time period, and to compare the incremented retry counter to a retry limit of failed connection attempts. Additionally, the remote control unit includes instructions to generate the alarm via the at least one of the audio, the haptic, or the visual indication component in response to a result of the comparison meeting the retry limit of failed connection attempts.

According to at least one aspect of the present disclosure, a wirelessly controllable hoist system is disclosed. The system includes a hoist assembly that includes a hoist wireless transceiver configured for personal area network communications. The system also includes a remote control unit operable to wirelessly control the hoist assembly. The remote control unit includes a remote wireless transceiver configured for communication with the hoist wireless transceiver of the hoist assembly via a personal area network, and one or more of an audio, a haptic, or a visual indication component affixed to a housing of the remote control unit. The audio, haptic, or visual indication component are operable to generate a respective audible or visible alarm. The remote control unit also includes a processor in communication with the remote wireless transceiver and memory storing instructions which are executed by the processor to initiate a check timer corresponding to a check time period to occur before a connection request is attempted, and to initiate, in response to the check timer having met or exceeded the check time period, a connection timer corresponding to a time period during which the connection attempt is made. The remote control unit also includes instructions to perform the connection attempt to establish bi-directional communication with the hoist assembly during the time period, and increment a retry counter in response to a failed connection attempt occurring during the time period. The remote control unit further includes instructions to compare the incremented retry counter to a retry limit of failed connection attempts, and to generate the alarm via the at least one of the audio, the haptic, or the visual indication component in response to a result of the comparison meeting the retry limit of failed connection attempts.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a view of an illustrative wirelessly controlled hoist system according to one or more aspects shown and described herein;

FIG. 2 depicts a close-up view of an illustrative wirelessly controlled hoist assembly and remote control unit according to one or more aspects shown and described herein;

FIG. 3 provides a view of an illustrative remote control unit for wirelessly controlling a hoist assembly according to one or more aspects shown and described herein;

FIG. 4 depicts an exploded view of various components of an illustrative carriage component and hoist assembly according to one or more aspects shown and described herein;

FIG. 5 depicts a block diagram of internal components of the illustrative remote control unit according to one or more aspects shown and described herein;

FIG. 6 depicts a block diagram of internal components of the illustrative hoist assembly according to one or more aspects shown and described herein;

FIG. 7 illustrates a flow diagram of lost remote control unit detection according to one or more aspects shown and described herein;

FIG. 8 schematically illustrates an example depiction of a remote control unit inside a coverage area; and

FIG. 9 schematically illustrates an example depiction of a remote control unit outside a coverage area.

### DETAILED DESCRIPTION

The present disclosure relates to embodiments of interconnected components of an overhead hoist system that allows for a hoist assembly to be coupled, untethered, to a wall-mounted control unit, and/or a remote control unit. The embodiments described herein provide for the detection and avoidance of remote control unit loss through the untethered communications link established between the remote control unit and the hoist assembly. Although described hereinafter with respect to an overhead hoist system, it will be appreciated that the detection and avoidance of loss of the remote control unit may also be utilized with respect to a mobile lift system (e.g., a freestanding lift unit). Regardless, the hoist units are communicatively coupled to various additional components, including an untethered, wall-mounted control, a remote control, and the like. The communications between the various components allow for pairing of hoist assemblies with particular remote control units utilizing personal area network communication standards to detect when a remote control unit is beyond a predetermined distance from the paired hoist assembly and generate an audio and/or visual alert on the remote control unit indicative of the loss.

The phrase “communicatively coupled” is used herein to describe the interconnectivity of various components of the lifts for the purposes of transmitting and/or receiving signals, transmitting and/or receiving data, and/or the like and means that the components are generally coupled wirelessly such that signals may be exchanged between the components. It should be understood that other means of connecting the various components of the system not specifically described herein (e.g., wired connections) are included without departing from the scope of the present disclosure.

As will be evident from the present disclosure, a remotely control that is paired to a specific hoist assembly may provide may provide several advantages over controls that are tethered to a hoist assembly or even wall-mounted controls. For example, the remote control unit described herein are not limited to a particular position within a room, allowing the caregiver to be closer to the subject, while not hindering movement of certain hoists, such as rail-mounted hoists, as such overhead hoists must sometimes move over other equipment. Having a wall-mounted control unit requires the caregiver to be relatively distant from the subject, and require a caregiver to possibly lose sight of the subject in order to visually access the controls contained thereon. Further, having a tethered control would cause the control to get caught or otherwise impede movement of the hoist when the hoist is moved over equipment. Additionally, sometimes the tether may not be reachable in instances where ceilings are high and/or users are short, but a remote control is always reachable. Remote control units may sometimes be lost or misplaced, e.g., a caregiver leaves the room with the remote in a pocket. The present disclosure, however, overcomes this potential issue by utilizing a personal area network standard to detect distance of the remote control unit and generate indicia to the caregiver that the remote is in their possession, e.g., pocket, cart, etc., when they leave the room and/or proximity relative to the hoist.

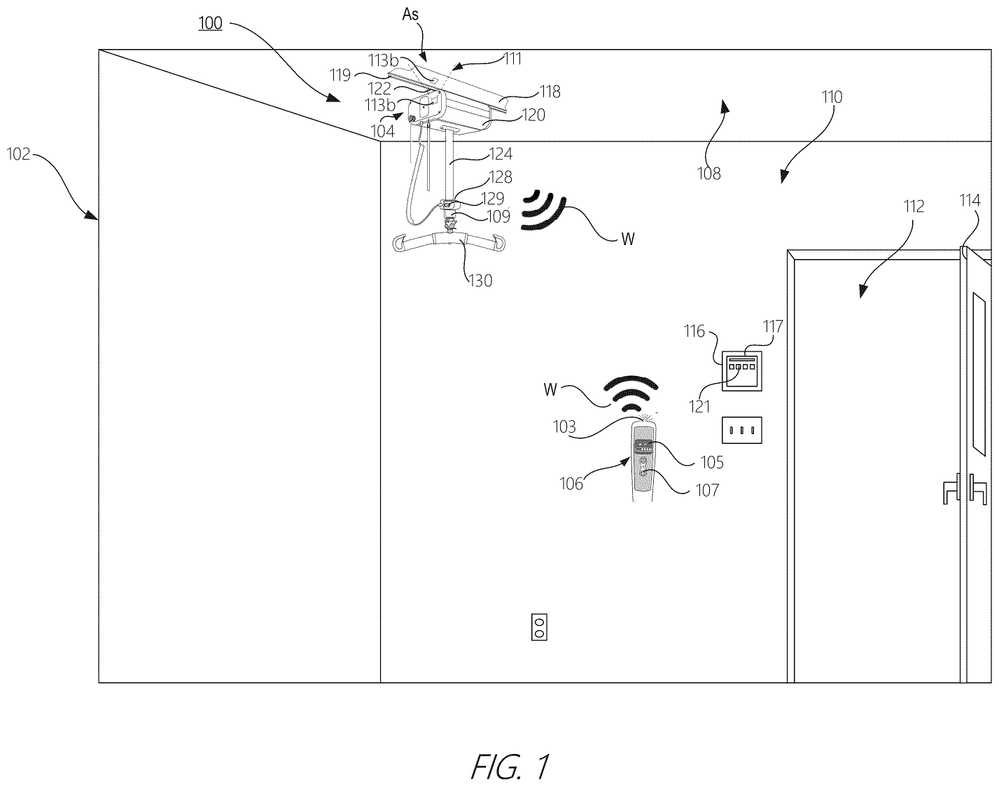

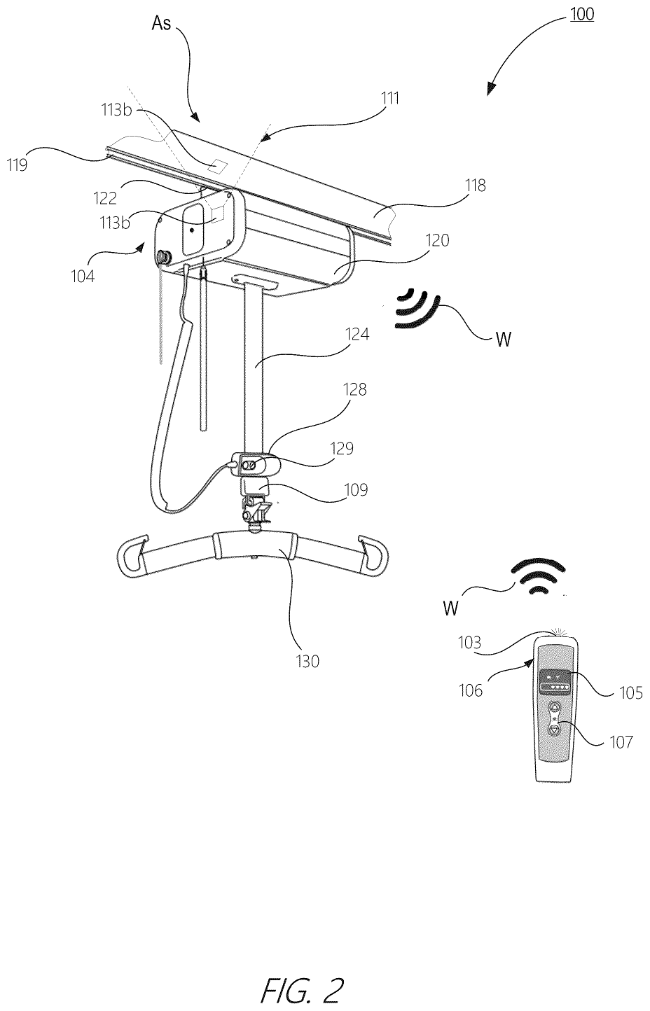

Referring now to FIGS. 1-2, there is shown an illustrative implementation of a wirelessly controlled hoist system 100 with remote control unit loss detection and/or prevention in accordance with some aspects shown and described herein. In the example illustration of FIGS. 1-2, the wirelessly controlled hoist system 100 includes a hoist assembly 104 that is movably attached via a carriage component 122 to a rail 118 attached to a ceiling 108 of a room 102 of a care facility and remote control unit 106 configured to remotely control operations of the hoist assembly 104 via one or more wireless communications protocols. The room 102 includes one or more walls 110, an entranceway 112, a door 114, and the like. In some aspects, the wirelessly controlled hoist system 100 may include a wall-mounted control unit 116, in wired or wireless communication with the hoist system 100. It will be appreciated that the room 102 may correspond, for example and without limitation, to a hospital room, a ward, an operating room, a rehabilitation room, a nursing home residential room or clinic, a doctor's office, or a residential room equipped with the hoist system 100. In accordance with other aspects, the rail 118 may be configured to extend along a ceiling of hallway, corridor, or other area of a care facility.

The hoist assembly 104 shown in FIGS. 1-2 may include a lift strap 124 operably coupled to a motor (not shown) within the hoist assembly 104. In some aspects, the lift strap 124 may be configured to assist in the supporting and/or lifting of a subject. Accordingly, the motor may raise or lower the lift strap 124, thereby effectuating the raising or lowering of the subject. A sling bar 130 may be coupled to an end of the lift strap 124 opposite the end of the lift strap 124 operably connected to the hoist assembly 104, e.g., the internal motor thereof. While a sling bar 130 is shown in FIGS. 1-2, it will be appreciated that other suitable attachments may be coupled to the lift strap 124 to perform a variety of lifting and/or lowering operations. Alternatively, one or more attachments, e.g., a sling, harness, etc., may be removably coupled to the lift strap 124.

The wirelessly controlled hoist system 100 shown in FIGS. 1-2 may further include a load sensor 109, which may be arranged and configured to sense various characteristics and/or parameters associated with the hoist assembly 104. For example, the load sensor 109 may be positioned on or adjacent to the lift strap 124 to sense a tension of the lift strap 124, which may be used to determine a type of sling bar 130 being used, whether a subject is presently being supported by the sling bar 130, the weight of a subject supported by the sling bar 130, and/or a positioning of a subject supported by the sling bar 130. As such, the load sensor 109 may be a load cell, such as a hydraulic load cell, a pneumatic load cell, a piezoelectric load cell, a strain gauge load cell, and/or the like. It will be appreciated that while only a single load sensor 109 is shown in FIGS. 1-2, more than one load sensor may also be used without departing from the present disclosure. For example and without limitation, the hoist system 100 may include a plurality of load sensors 109 positioned on or adjacent to the lift strap 124. In accordance with some aspects contemplated herein, the load sensor 109 may provide information that is transmitted to one or more components of the hoist system 100 and used for a plurality of purposes, such as displaying load related data to a caregiver or the like. The hoist system 100 may also include one or more other sensors that sense various characteristics associated with the hoist system 100, including, for example and without limitation, movement of the hoist assembly 104, movement of the lift strap 124, orientation of the sling bar 130, type of attachment coupled to the lift strap 124, and/or the like. One illustrative, non-limiting example of such a sensor is a potentiometer.

According to some aspects illustrated in FIGS. 1-2, the hoist system 100 may further include a locating system 111. The locating system 111 generally includes a first component 113a and a second component 113b. The first component 113a and the second component 113b function as a receiver and a transmitter. That is, the first component 113a may be a receiver or a transmitter and the second component 113b may be a transmitter or a receiver. For example, when the first component 113a is implemented as a receiver, the second component 113b may be implemented a transmitter, and vice versa.

Accordingly, when the first component 113a and the second component 113b are configured as a transmitter, the components 113a-113b are generally any device or component that transmits, displays, or otherwise provides an encoded signal that is obtainable or otherwise receivable by the receiver. Similarly, when the first component 113a and the second component 113b are configured as a receiver, the components 113a-113b are generally any device or component that obtains or otherwise receives the encoded signal from the transmitter. The transmitter may be a passive device such as a printed code (such as a barcode, a QR code, or the like), or may be an active device such as an infrared (IR) beacon, a radio frequency identification (RFID) emitter or tag, a wireless transmitter, or the like. The transmitter is printed, attached, or otherwise affixed to an area on or around the rail 118, a portion of the hoist assembly 104, a portion of the carriage component 122, and/or the like. In some aspects where the transmitter is an RFID emitter or tag affixed to the rail 118, the RFID emitter or tag may be affixed in such a manner that the RFID signal is not propagated through the rail 118 (e.g., by coupling the RFID emitter or tag to an insulation device or the like).

According to other aspects shown and illustrated in FIGS. 1-2, the receiver may be an imaging device, an IR receiver, an RFID detector (e.g., an electromagnetic field generator), a wireless receiver (e.g., a radio utilizing a wireless technology standard such as Bluetooth or 802.11x), or the like. In a particular embodiment, the receiver may include, for example, a CS468 RFID reader and a CS790 antenna available from Convergence Systems Ltd. of Hong Kong, which may be used in conjunction with one another to shape an active area of the receiver. The receiver may be attached to or integrated with a component of the hoist system 100, such as, for example, the hoist assembly 104 or the carriage component 122, or may be attached or integrated on or near the rail 118. The transmitter and the receiver may further be positioned or otherwise arranged such that the encoded signal provided by the transmitter is received by the receiver when the transmitter and the receiver pass one another due to movement of the carriage component 122 along the rail 118, as described in greater detail herein. For example, the transmitter and the receiver may be arranged such that a line-of-sight alignment is achieved between the transmitter and the receiver when the carriage component 122 passes a particular location along the rail 118.

As depicted in FIGS. 1-2, the first component 113a is coupled to the hoist assembly 104 and the second component 113b is affixed to the rail 118. It will be understood that these locations are merely illustrative, and the first component 113a and the second component 113b may be located elsewhere with respect to the hoist system 100. Discussion hereinafter refers to the first component 113a coupled to the hoist assembly 104 configured as a receiver, and the second component 113b positioned on the rail 118 configured as a transmitter for example purposes only.

The portion of the locating system 111 that functions as the receiver (e.g., the first component 113a or the second component 113b) may sense a sensed area As that generally encompasses an area adjacent to the receiver. The sensed area As, as shown in FIGS. 1-2, may generally be an area bound by the dashed lines, which extends from the hoist assembly 104 to a portion of the rail 118. That is, the sensed area As may be an area completely surrounding the receiver in some embodiments. In other aspects, the sensed area As may be an area encompassed by the field of view of the receiver, such as when the receiver is an imaging device or an IR receiver. According to other aspects, the sensed area As may be an active region that is shaped through use of appropriate antennas and readers such that only components in a particular area (e.g., along the rail 118) are sensed.

The portion of the locating system 111 that functions as the transmitter (e.g., the first component 113a or the second component 113b) may be located in any location on the rail 118 throughout the room 102, particularly in locations where it may be advantageous to determine a location of the hoist assembly 104. It should be understood that the locating system 111 is only one illustrative example of a system that is used to determine a location of the hoist assembly 104. Other systems and methods are also contemplated, such as, for example, one or more signal triangulation algorithms that are adapted to determine a location based on signals wirelessly transmitted to or from the hoist assembly 104, other tracking hardware such as global positioning satellite (GPS) hardware, and/or the like.

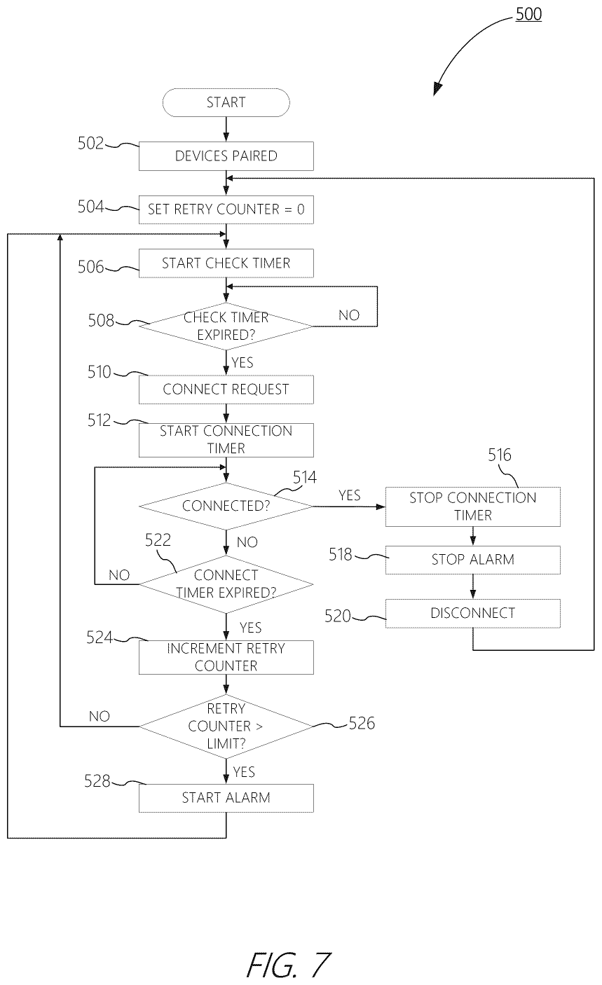

According to aspects contemplated and disclosed herein, one or more components of the hoist system 100, e.g., the hoist assembly 104 and/or components thereof, may be operated via a hand control unit 128 operably coupled and in close proximity to the hoist assembly 104, a wall-mounted control unit 116 that is in wired or wireless communication with the hoist assembly 104, and/or the remote control unit 106 that is paired with and in wireless communication W with the hoist assembly 104 (as discussed in greater detail below with respect to FIG. 7). As shown in FIGS. 1-2, the hand control unit 128 is directly wired to the hoist assembly 104. However, in accordance with other aspects, the hand control unit 128 and/or wall-mounted control unit 116 may be omitted, such that control of the hoist assembly 104 is accomplished using the remote control unit 106.

The hand control unit 128 depicted in FIGS. 1-2 may include a display (not shown), a sensing device (not shown), and one or more user controls 129. According to some aspects contemplated herein, the one or more user controls 129 may be implemented as hardware components that receive inputs from a user and transmit signals corresponding to the inputs, e.g., buttons, knobs, joystick, etc., or may be implemented as a touch screen, voice activated, etc. In some implementations, the one or more user controls 129 may be combined into a single device with a display, e.g., a touch screen implementation wherein the one or more user controls 129 are displayed on the display as icons, graphics, etc. According to some aspects, the user controls 129 may, for example, enable a user, e.g., a caregiver, to raise/lower the lift strap 124 and/or sling bar 130, activate/deactivate the motor (not shown), move the hoist assembly 104 along the rail 118, and the like. According to various aspects capable of implementation in accordance with the subject disclosure, a sensing device (not shown) of the hand control unit 128 contains hardware for sensing a code and transmitting data corresponding to the code. Illustrative hardware includes, but is not limited to, an imaging device, an IR receiver, an RFID detector (e.g., an electromagnetic field generator), a wireless receiver (e.g., a radio utilizing a wireless technology standard such as Bluetooth® or 802.11x), or the like. Further, the sensing device (not shown) may be implemented as an imaging device that is adapted to read a barcode (or any other symbology, QR code, or the like). For example, the barcode may correspond to a subject identity, a preselected location of the hoist assembly 104 and/or sling bar 130, an identity of the caregiver, and the like.

The wall-mounted control unit 116 may include, for example, a display 117 and/or one or more user interface controls 121. The display 117 is generally any liquid crystal display (LCD), light emitting diode (LED) display, electronic ink (e-ink) display, or the like that can display information to a user. In accordance with some aspects, the display 117 may be configured as an interactive display that can receive user inputs (e.g., a touch screen display or the like). The one or more user interface controls 121 may be hardware components that receive inputs from a user and transmit signals corresponding to the inputs. While the user interface controls 121 are depicted in FIG. 1 in the form of a touch screen, other user interface controls are contemplated and included within the scope of the present discussion, including, for example and without limitation, a keyboard, a mouse, a joystick, a remote control, a pointing device, a video input device, an audio input device, a haptic feedback device, and/or the like. In some aspects, the display 117 and one or more of the user interface controls 121 may be combined into a single device, such as a touchscreen display or the like (as depicted in FIGS. 1-2). The display 117 and/or the one or more user interface controls 121 may be used, for example, to allow a user or caregiver to interact with the wall-mounted control unit 116 for the purposes of moving components up/down, moving components laterally, activating the hoist assembly 104, pairing a subject with the hoist assembly, returning the hoist assembly 104 to a “home” position/location, receiving information from the hoist assembly 104 (e.g., battery status, weight of load supported by the hoist assembly 104, movement history, associated subjects, etc.), performing an emergency stop of the hoist assembly 104, resetting the hoist assembly 104, facilitating pairing of the remote control unit 106 with the hoist assembly 104, and/or the like.

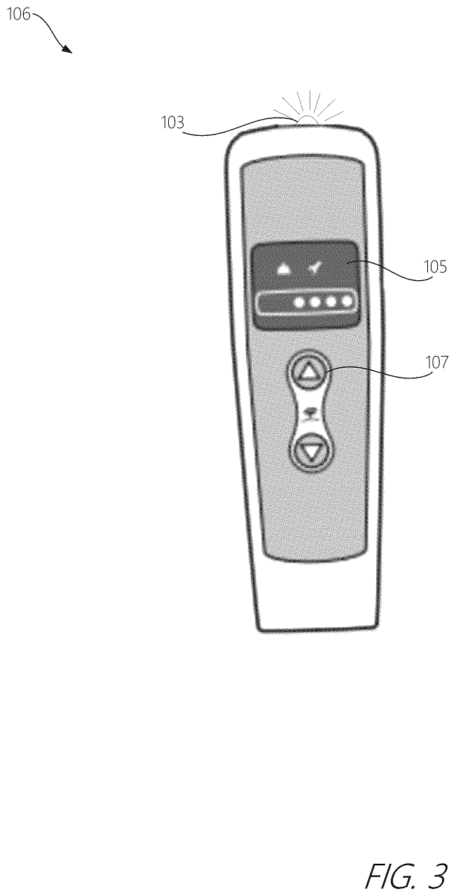

As shown in FIGS. 1-2, and with reference to FIG. 3, the remote control unit 106 of the hoist system 100 includes one or more components that provide functionality for using the hoist assembly 104. For example, the remote control unit 106 may include one or more components for causing the motor within the hoist assembly 104 to extend or retract the lift strap 124, moving components up/down, moving components laterally, activating the hoist assembly 104, pairing a subject with a hoist assembly 104, returning a hoist assembly 104 to a “home” position/location, receiving information from the hoist assembly 104 (e.g., battery status, weight of load supported by the hoist, movement history, associated subjects, etc.), performing an emergency stop of the hoist assembly 104, resetting the hoist assembly 104, and/or the like.

As shown in FIGS. 1-3, the remote control unit 106 may include, for example, an indicator 103 (e.g., a visible indicator), a speaker (not shown), a vibrator (not shown), a display 105 and/or one or more user interface controls 107. The display 105 is generally any liquid crystal display (LCD), light emitting diode (LED) display, electronic ink (e-ink) display, or the like that can display information to a user. In some embodiments, the display 105 may be configured as an interactive display that can receive user inputs (e.g., a touch screen display or the like). The one or more user interface controls 107 may be hardware components that receive inputs from a user and transmit signals corresponding to the inputs. The embodiments of FIGS. 1-3 include user interface controls 107 in the form of physical buttons. However, other user interface controls are contemplated and included within the scope of the present disclosure, including, but not limited to, a keyboard, a mouse, a joystick, a remote control, a pointing device, a video input device, an audio input device, a haptic feedback device, a touch screen, and/or the like.

According to some aspects, the remote control unit 106 may be constructed of suitable materials capable of being disinfected, cleaned, and/or sterilized in accordance with sterile or clean room settings. For example, the remote control unit 106 may be constructed of a polymer meeting IPx4 or higher standards, allowing for steam and/or disinfectant cleanings. Suitable polymers may include, for example and without limitation, ABS (Acrylonitrile Butadiene Styrene), ABS+PC blend (Polycarbonate), Polyamide, Polycarbonate, PMMA (Polymethyl Methacrylate, Plexiglas), Phenolharz, PPE (Polyphenylene Ether)/PPO (Polyphenylene Oxide), SEBS (Styrene Ethylene Butadiene Styrene), and/or combinations thereof.

In accordance with some aspects, the display 105 and one or more of the user interface controls 107 of the remote control unit 106 may be combined into a single device, such as a touchscreen display or the like. The display 105 and/or the one or more user interface controls 107 may be used, for example, to allow a user to interact with the remote control unit 106 for the purposes of moving components up/down, moving components laterally, activating the hoist assembly 104, pairing a subject with a hoist assembly 104, returning the hoist assembly 104 to a “home” position/location, receiving information from the hoist assembly 104 (e.g., battery status, weight of load supported by the hoist assembly 104, movement history, associated subjects, etc.), performing an emergency stop of the hoist assembly 104, resetting the hoist assembly 104, and/or the like. According to other aspects, an audible, haptic, tactile, or visual alert may be generated via the indicator 103, speaker (not shown), vibrator (not shown) in response to a determination that the remote control unit 106 is outside a predetermined distance from the hoist assembly 104, as discussed in greater detail below with respect to FIG. 7.

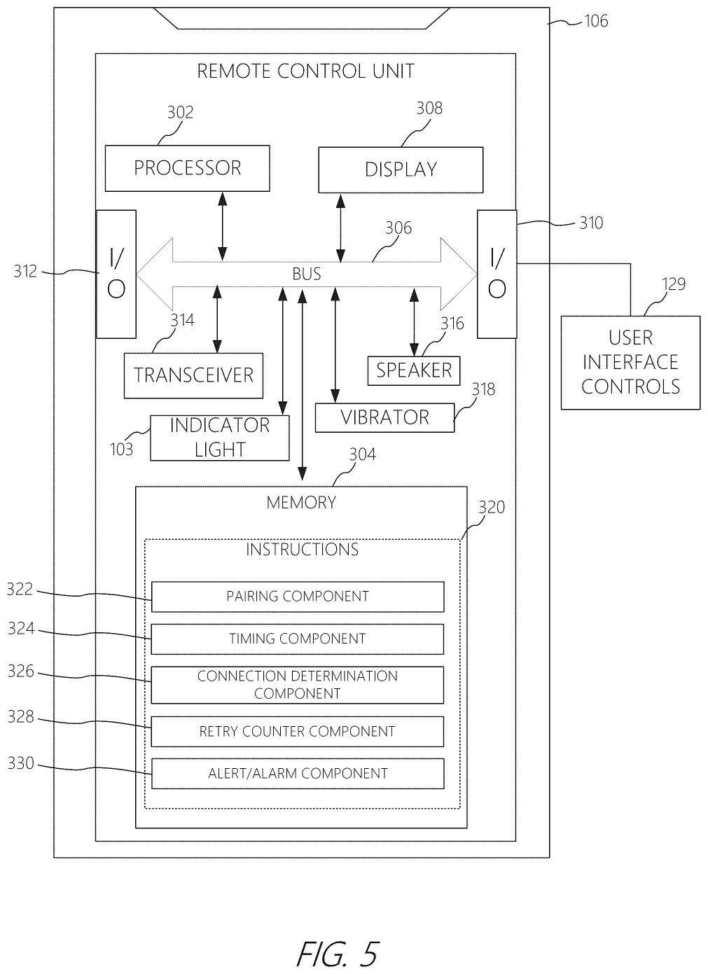

According to some aspects, the remote control unit 106 may include a near field or personal area network transceiver, capable of establishing bi-directional communications with the hoist assembly 104. As one non-limiting example, such a transceiver may be implemented as a Bluetooth® Low Energy transceiver, Wi-Fi transceiver, Zigbee®, and/or the like. For example, a class of Bluetooth® Low Energy devices includes Bluetooth® beacons, which use Bluetooth® Low Energy proximity sensing to transmit a universally unique identifier picked up by a compatible application or operating system, which can be used to determine the physical location of the device. Additional discussion regarding the transceiver is presented below with respect to FIG. 5. Accordingly, the remote control unit 106 may be implemented as a standalone unit that is paired, e.g., communicatively coupled, with a single hoist assembly 104. That is, the remote control unit 106 may solely be used for the purposes of displaying information pertaining to a particular subject, displaying information pertaining to the hoist system 100 (including components thereof) with which it is paired, providing a user input that is usable to control various components, such as the hoist assembly 104, and/or the like. As such, the remote control unit 106 may only have software programming that is suitable for the purposes described herein, and may lack programming for executing other processes. Additional details regarding the remote control unit 106 will be described herein with respect to FIG. 5.

As briefly discussed above, the hoist assembly 104 of the wirelessly controlled hoist system 100 in FIGS. 1-2 is movable along the rail 118 via the carriage component 122, enabling the hoist assembly 104 to slide along the rail 118. For example, in a ward or multi-subject room, the hoist assembly 104 may slide along the rail 118 across the ceiling 108 so as to be positioned over different locations within the room 102. It will be appreciated that the illustration of FIG. 1 depicts a partial view of the rail 118 for example purposes only. Accordingly, depending upon the facility in which the wirelessly controlled hoist system 100 is emplaced, the rail 118 may be of varying lengths and orientations, e.g., straight, curved, and/or a combination thereof. Although not shown in FIG. 1, the rail 118 may include one or more ends or termination points, defining the total length of the rail 118. In some aspects, such ends or termination points may include a stopper to halt transit of the hoist assembly 104 to prevent damage thereto. End caps may also be included covering the ends of the rail 118, as will be understood. The rail 118 depicted in FIG. 1 may include a channel 119 defined therein for receiving a portion of the carriage component 122 to facilitate movement of the hoist assembly 104 along the rail 118. It will be understood that while a channel 119 is shown in FIG. 1, other forms of rail and carriage guidance may be used in accordance with other aspects contemplated herein including, for example and without limitation, dual-rails, L-shaped rails, or the like.

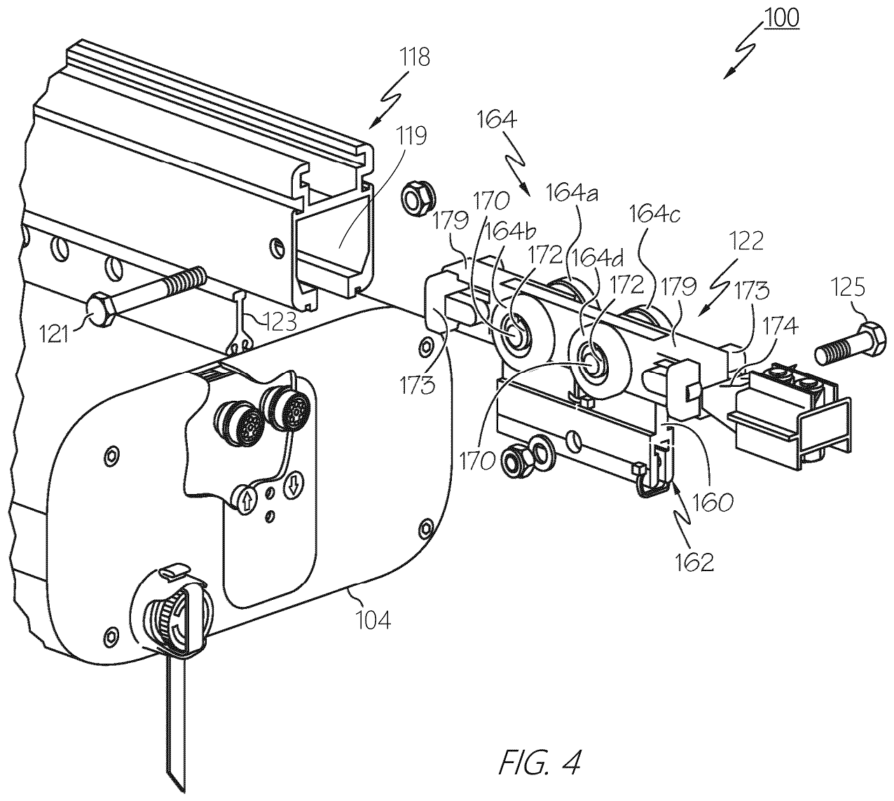

The carriage component 122 may be configured to slideably engage the rail 118, e.g., within the channel 119, via any suitable motive means including, for example and without limitation, one or more wheels, ball bearings, chain, belt, or the like. According to some aspects, the carriage component 122 may be self-moving, e.g., including one or more motors or drives operable to rotate the motive means to move the hoist assembly 104 along the rail 118. Accordingly, the aspects illustrated and described herein may utilize the carriage component 122 to slide, roll, or otherwise move along the rail 118 as a subject is being moved to a desired location, or to position the hoist assembly 104 at a desired position along the travel of the rail 118. FIG. 4, discussed in greater detail below, provides additional information on the carriage component 122.

With respect to FIG. 4, there is shown an exploded view of the carriage component 122 and rail 118, illustrating the hoist assembly 104 mechanically coupled to the carriage component 122, thereby facilitating movement of the hoist assembly 104 along the rail 118. According to some aspects set forth herein, the hoist assembly 104 a connection rail 123 which is mounted to a top surface of the hoist assembly 104. The connection rail 123 facilitates connecting and securing the hoist assembly 104 to the carriage component 122. As shown in FIG. 4, the connection rail 123 has a T-shaped configuration and the carriage component 122 has a receiving slot 162 with a complimentary configuration for receiving the connection rail 123. The carriage component 122 may be secured to the connection rail 123 with a fastener 125, such as a bolt and nut as depicted in FIG. 4, which extends transversely through openings in the carriage component 122 and a corresponding opening in the connection rail 123.

The carriage component 122 shown in FIG. 4 generally includes a carriage body 160 having an extension 166 to which a plurality of support wheels 164a, 164b, 164c, and 164d (collectively, support wheels 164) are rotatably attached for supporting the carriage component in the rail 118. The support wheels 164 facilitate positioning the carriage component 122 and hoist assembly 104 along the length of the rail 118. In the embodiments described herein, the carriage component 122 is depicted with four support wheels 164. However, it is contemplated that the carriage component 122 may be constructed with fewer than four (4) support wheels 164. For example, in some embodiments, the carriage component 122 may be constructed with one or two support wheels 164 (e.g., a pair of support wheels 164). Accordingly, it should be understood that the carriage component 122 includes at least one support wheel 164. The support wheels 164 are positioned on axles 170 which extend transversely through the carriage body 160. Each support wheel 164 is secured to the axle 170 with a fastener, such as retaining clips 172, such that the support wheels 164 are rotatable on the axle 170.

According to the aspects of the carriage component 122 illustrated in FIG. 4, the support wheels 164 are passive (e.g., the support wheels 164 are not actively driven with a motor or a similar drive mechanism) and the hoist assembly 104 is manually traversed along the rail 118 (e.g., such as when a user pushes or pulls the hoist assembly 104 along the rail 118). However, in alternative embodiments (not shown), the support wheels may be actively driven, such as when the support wheels are coupled to a motor or a similar mechanism. In such embodiments, referring also to FIGS. 1-2, the drive mechanism may be communicatively coupled to a control unit (such as the hand control unit 128, the wall-mounted control unit 116, and/or the remote control unit 106) which actuates the drive mechanism and facilitates traversing the hoist assembly 104 along the rail 118 with the drive mechanism. As such, a caregiver may actuate one or more user interface controls on the hand control unit 128, the wall-mounted control unit 116, and/or the remote control unit 106 to cause the hoist assembly 104 to traverse along the rail 118. Further, a caregiver may adjust a speed, a direction, and/or the like of the movement of the hoist assembly 104 along the rail 118 via the one or more user interface controls on the hand control unit 128, the wall-mounted control unit 116, and/or the remote control unit 106. Further, a user may utilize data obtained regarding the hoist system 100, a subject, and/or the like to determine potential movement parameters (e.g., speed, direction, starting/stopping, and/or the like).

According to some aspects, the one or more user controls 129 on the hand control unit 128, the wall-mounted control unit 116, and/or the remote control unit 106 may be provided to a user based on potential movement parameters. For example, if a subject has a particular mobility score or the like, the one or more user controls 129 on the hand control unit 128, the wall-mounted control unit 116, and/or the remote control unit 106 may be adjusted, limited, provided, and/or the like based on the mobility score. In accordance with another example, a speed may be limited to a particular speed (e.g., a maximum, not-to-exceed speed) for a particular mobility score such that, when the user or caregiver actuates the one or more user controls 129 on the hand control unit 128, the wall-mounted control unit 116, and/or the remote control unit 106, the hoist assembly 104 will not move along the rail 118 at a speed higher than the limited particular speed.

As shown in FIG. 4, the carriage component 122 may further include bumper assemblies 179 positioned on either end of the carriage body 160 in some embodiments. The bumper assemblies 179 may be attached to the carriage body 160 and secured in place with the axles 170 which extend transversely through the carriage body 160. The bumper assemblies 179 may include rubber end caps 173 which cushion the carriage component 122 when the carriage component 122 encounters an end stop 174 located at either end of the rail 118, the end stops 174 being secured in the rail 118 by a fastener 125, which may be a bolt and a nut in some embodiments. According to some aspects of the carriage component 122 described herein, the bumper assemblies 179 are optional and, as such, it should be understood that the carriage component 122 may be constructed without the bumper assemblies 179.

Turning now to FIG. 5, there is shown a block diagram of internal components of the illustrative remote control unit 106 according to one or more aspects shown and described herein. As shown in FIG. 5, the remote control unit 106, which is capable of implementing methods set forth herein, includes a processor 302, which performs an example method by execution of processing instructions 320 that are stored in memory 304 connected to the processor 302, as well as controlling the operations of the hoist assembly 104 in accordance with some aspects discussed herein. The various components of the remote control unit 106 may be connected by a data/control bus 306.

The remote control unit 106 may include one or more input/output (I/O) interface devices 310 and 312 for communicating with external devices. For example, the I/O interface 310 may communicate with one or more external devices for one or more purposes, e.g., displaying information, receiving external input, e.g., start/stop commands, pairing requests, raise/lower commands, etc., input from one or more user controls 129, such as a switch, key, icon, and/or the like. The I/O interface 312 may communicate with external devices such as a user device (e.g., a mobile communications device, IoT device, and the like), via a suitable a communications link. The communications link established by the I/O interface 312 may be implemented in accordance with any suitable wide or personal area network standards including, for example and without limitation, 802.11(x), Bluetooth, NFC, I/R, or the like. In accordance with some aspects, such a communication link may be used to establish bi-direction communication with an external device for any suitable operation, e.g., programming of the remote control unit 106, sending/receiving data regarding a hoist assembly 104, sending/receiving data regarding subject or caregiver, and the like. The I/O interface 310 may be implemented as a suitable transceiver capable of establishing bi-directional communication with external devices. In such aspects, the communications link established by the I/O interface 310 may be implemented as a near-field or personal area network, e.g., Bluetooth® or other suitable short-range wireless technology standard. In other aspects, such a communications link may be an infra-red or near infra-red wireless communication link.

The remote control unit 106 shown in FIG. 5 may further include a separate transceiver 314 operably coupled to the I/O interfaces 310, 312 and processor 302 via the data/control bus 306. In some aspects, the transceiver 314 may be configured to communicate with a corresponding transceiver of a hoist assembly 104, as discussed below. Suitable examples of such a transceiver 314 may include, but are not limited to, a NUCLEO-WB55RG board or dongle by STMicroelectronics International N.V., which includes Bluetooth® specification v5.4, IEEE 802.15.4-2011 PHY and MAC, supporting Thread® 1.3, Matter, and Zigbee® 3.0. Accordingly, in some aspects, the transceiver 314 may operate independently of the I/O interfaces 310, 312, via an integrated antenna.

In accordance with some aspects, the remote control unit 106 may include one or more user controls 129, as discussed in greater detail above. Further, according to the example implementation of FIG. 5, the remote control unit 106 includes a display 308 operably coupled to the processor 302 via the data/control bus 306. Such a display 308 may be implemented, for example and without limitation, as a touchscreen, LCD, LED, eInk, or other suitable display format capable of providing visual information to a caregiver. In some aspects, the display 308 may be configured to generate a visual indicator as to, for example and without limitation, battery status, pairing, distance from hoist assembly 104, and the like.

As shown in FIG. 5, the remote control unit 106 may further include a speaker 316 operable to generate an alarm or alert in response to a determination that the remote control unit 106 has exceeded a predetermined distance from the hoist assembly 104 with which the remote control unit 106 is paired, as discussed in greater detail below with respect to FIG. 7. In accordance with varying aspects, the speaker 316 may be appropriately sized and shaped to fit within the remote control unit 106. According to further aspects, the alarm or alert may be generated in addition to or in place of activation of the indicator 103. For example, when a determination is made that the remote control unit 106 is outside a predetermined proximity to the paired hoist assembly 104, the speaker 316 may be activated to generate the alarm/alert while simultaneously the indicator 103 (e.g., a light or the like) illuminates in a flashing or continuous manner. Suitable examples of the alarm/alert generated by speaker 316 may include, for example and without limitation, a chirp, beep, tone, voice alert, and/or the like.

The example remote control unit 106 shown in FIG. 5 may also include a vibrator 318, e.g., a small motor that spins an offset weight to create vibrations. It will be appreciated that other haptic feedback mechanisms may be incorporated into the remote control unit 106 in place of or in addition to the vibrator 318 so as to generate a haptic notification to a caregiver regarding the remote control unit 106, and the use of a vibrator 318 is intended solely as one non-limiting example of such a component. According to varying aspects disclosed and contemplated herein, the vibrator 318 may be activated upon a determination that the remote control unit 106 has exceeded a predetermined distance away from the hoist assembly 104 with which the remote control unit 106 is paired. For example, when a determination is made that the remote control unit 106 is outside a predetermined proximity to the paired hoist assembly 104, the vibrator 318 may be activated to vibrate the remote control unit 106 simultaneously (or independent of) the speaker 316 generating the alarm/alert and/or the indicator 103 illuminating in a flashing or continuous manner.

Although not illustrated in FIG. 5, the remote control unit 106 may be equipped with a suitable internal power supply, capable of providing electrical power to the various components included in the remote control unit 106. Suitable examples of such a power supply may include, for example and without limitation, alkaline batteries, lithium-ion batteries, nickel-cadmium batteries, and/or other types of disposable and/or rechargeable batteries. It will be appreciated that the remote control unit 106 may further include a power supply compartment configured to receive and store the aforementioned power supply. In accordance with varying aspects, the power supply compartment may be accessible to the caregiver, e.g., to replace disposable batteries. In other aspects, such as an integrated, rechargeable aspect, a port, such as a USB standard-based port, may be used to effectuate recharging of the power supply. According to other aspects, such recharging may be accomplished via induction charging.

It will be appreciated that the remote control unit 106 illustrated in FIG. 5 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms.

According to one example embodiment, the remote control unit 106 includes hardware, software, and/or any suitable combination thereof, configured to interact with an associated user, a networked device, networked storage, remote devices, hoist assemblies 104, and/or the like.

The memory 304 illustrated in FIG. 5 as a component of the remote control unit 106 may represent any type of non-transitory computer readable medium such as random access memory (RAM), read only memory (ROM), magnetic disk or tape, optical disk, flash memory, or holographic memory. In one embodiment, the memory 304 comprises a combination of random access memory and read only memory. In some embodiments, the processor 302 and memory 304 may be combined in a single chip. The network interface(s) 310, 312 allow the remote control unit 106 to communicate with other devices via a computer network, (e.g., the Internet) or direct communication with such other devices, and may comprise a modulator/demodulator (MODEM). Memory 304 may store data processed in the method as well as the instructions for performing the exemplary method.

The processor 302 can be variously embodied, such as by a single core processor, a dual core processor (or more generally by a multiple core processor), a digital processor and cooperating math coprocessor, a digital controller, or the like. The processor 302, in addition to controlling the operation of the remote control unit 106, executes instructions 320 stored in memory 304 for performing the method set forth hereinafter.

As shown in FIG. 5, the instructions 320 stored in memory 304 may include a pairing component 322, configured to facilitate pairing of the remote control unit 106 with an external device, e.g., the hoist assembly 104. In accordance with some aspects, the pairing component 322 may be configured to interact with the transceiver 314 to exchange a link key with the hoist assembly 104, establishing bi-directional communication between the remote control unit 106 and the hoist assembly 104.

The instructions 320 stored in memory 304 of the remote control unit 106 may further include a timing component 324 configured to implement a check timer corresponding to a predetermined period of time that occurs between connection requests. That is, the timing component 324 may initiate the start of the check timer which corresponds to a period before a connection request is sent to the paired hoist assembly 104. That is, the timing component 324 waits a predetermined period of time (e.g., a check time) before sending a connection request. In accordance with some aspects, this check time may correspond to a preselected period of time, e.g., every 5 seconds, every 10 seconds, every 15 seconds, 30 seconds, and so forth. In other aspects, the period of time may correspond to less than or equal to 5 seconds, less than or equal to 10 seconds, less than or equal to 15 seconds, less than or equal to 20 seconds, and the like. The timing component 324 may further be configured to implement a connection timer corresponding to a preselected time during which connection attempts are made with the hoist assembly 104. That is, the timing component 324 may activate a connection timer having a preselected duration during which the remote control unit 106 sends connection requests to the paired hoist assembly 104. In accordance with some aspects, this connection timer may be set to a preselected period of time, e.g., every 100 milliseconds, every 200 milliseconds, every 300 milliseconds, 500 milliseconds, or other suitable period of time.

As shown in FIG. 5, the instructions 320 stored in memory 304 may also include a connection determination component 326 configured to determine whether a wireless connection is present between the remote control unit 106 and the hoist assembly 104. According to some aspects, the connection determination component 326 may receive, via the transceiver 314, a wireless signal transmitted by the hoist assembly 104 to the remote control unit 106 indicating that bi-directional communications are present. The connection determination component 326 may be communicatively coupled to the timing component 324, so as to, in response to a check timer having elapsed, determine whether a connection with the hoist assembly 104 is present. In accordance with other aspects, the connection determination component 326 may be configured to determine, in conjunction with the timing component 324, whether a connection has been established during the connection timer.

The instructions 320 stored in memory 304 may further include a retry counter component 328 configured to track the number of connection attempts made to establish a connection with the hoist assembly 104. The retry counter component 328 may be configured with a preset number of allowable connection attempts, e.g., a limit on the number of failed connection attempts that may occur before an alert/alarm is generated. That is, the retry counter component 328 may be configured to allow a set number of connection attempts prior to enabling the alert/alarm component 330 to activate. In some aspects, the retry counter component 328 may implement a retry counter with a limit of five attempts, ten attempts, fifteen attempts, etc.

As shown in FIG. 5, the instructions 320 stored in memory 304 may also include an alert/alarm component 330 configured to initiate an alert/alarm via any of the mechanisms described above. That is, the alert/alarm component 330 may be configured to activate the indicator 103, the speaker 316, and/or the vibrator 318 indicating that a connection has been lost or cannot be established. Stated another way, the alert/alarm component 330 determines that the remote control unit 106 is outside a predetermined range relative to hoist assembly 104, and activates one or more of the aforementioned notification components, thereby providing audible, visual, and/or haptic notification of the location of the remote control unit 106. Additional interactions and functioning of the components described above with respect to the remote control unit 106 are discussed in greater detail below with respect to FIG. 7.

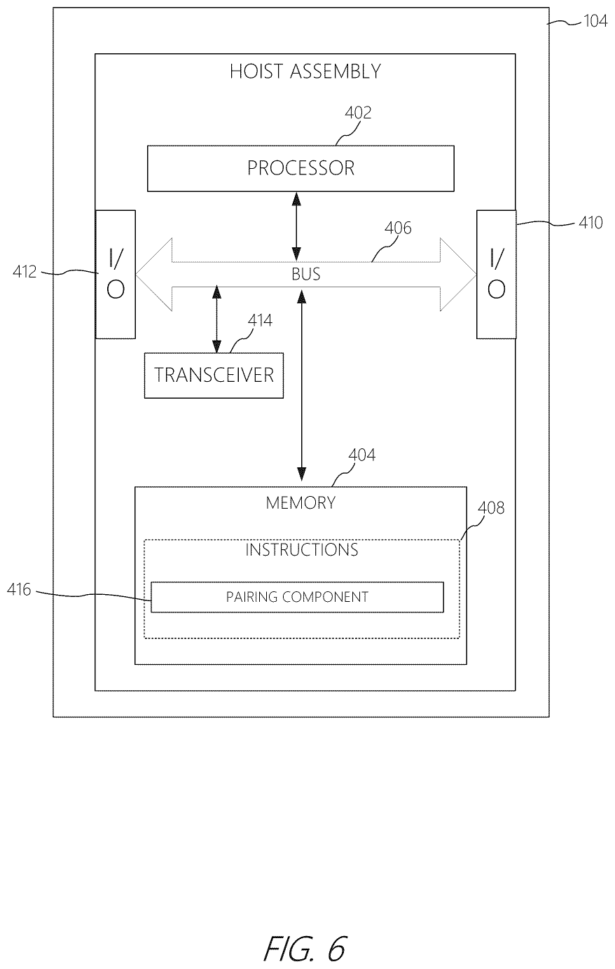

Referring now to FIG. 6, there is shown a block diagram of internal components of the illustrative hoist assembly 104 according to one or more aspects shown and described herein. As shown in FIG. 6, the hoist assembly 104, which is capable of implementing methods set forth herein, includes a processor 402, which performs an example method by execution of processing instructions 408 that are stored in memory 404 connected to the processor 402, as well as controlling the operations of the hoist assembly 104 in accordance with some aspects discussed herein. The various components of the remote control unit 106 may be connected by a data/control bus 406.

The hoist assembly 104 shown in FIG. 6 may include one or more input/output (I/O) interface devices 410 and 412 for communicating with external devices. For example, the I/O interface 410 may communicate with one or more external devices for one or more purposes, e.g., displaying information, receiving external input, receiving pairing requests, receiving start/stop commands, receiving load limits, receiving raise/lower commands, sending/receiving positioning data, and/or the like. The I/O interface 412 may communicate with external devices such as a user device (e.g., a mobile communications device, IoT device, and the like), via a suitable a communications link. The communications link established by the I/O interface 412 may be implemented in accordance with any suitable wide or personal area network standards including, for example and without limitation, 802.11(x), Bluetooth, NFC, I/R, or the like. In accordance with some aspects, such a communication link may be used to establish bi-direction communication with an external device for any suitable operation, e.g., programming of the hoist assembly 104, sending/receiving load limits, sending/receiving speed settings, sending/receiving position settings, and the like. The I/O interface 410 may be implemented as a suitable transceiver capable of establishing bi-directional communication with external devices. In such aspects, the communications link established by the I/O interface 410 may be implemented as a near-field or personal area network, e.g., Bluetooth® or other suitable short-range wireless technology standard. In other aspects, such a communications link may be an infra-red or near infra-red wireless communication link.

The hoist assembly 104 shown in FIG. 6 may further include a separate transceiver 414 operably coupled to the I/O interfaces 410, 412 and processor 402 via the data/control bus 406. In some aspects, the transceiver 414 may be configured to communicate with a corresponding transceiver of a remote control unit 106, as discussed below. Suitable examples of such a transceiver 414 may include, but are not limited to, a NUCLEO-WB55RG board or dongle by STMicroelectronics International N.V., which includes Bluetooth® specification v5.4, IEEE 802.15.4-2011 PHY and MAC, supporting Thread® 1.3, Matter, and Zigbee® 3.0. Accordingly, in some aspects, the transceiver 414 may operate independently of the I/O interfaces 410, 412, via an integrated antenna.

It will be appreciated that the hoist assembly 104 illustrated in FIG. 6 is capable of implementation using a distributed computing environment, such as a computer network, which is representative of any distributed communications system capable of enabling the exchange of data between two or more electronic devices. It will be further appreciated that such a computer network includes, for example and without limitation, a virtual local area network, a wide area network, a personal area network, a local area network, the Internet, an intranet, or any suitable combination thereof. Accordingly, such a computer network comprises physical layers and transport layers, as illustrated by various conventional data transport mechanisms, such as, for example and without limitation, Token-Ring, Ethernet, or other wireless or wire-based data communication mechanisms.

According to one example embodiment, the hoist assembly 104 includes hardware, software, and/or any suitable combination thereof, configured to interact with an associated user, a networked device, networked storage, remote devices, remote control units 106, and/or the like.

The memory 404 illustrated in FIG. 6 as a component of the hoist assembly 104 may represent any type of non-transitory computer readable medium such as random access memory (RAM), read only memory (ROM), magnetic disk or tape, optical disk, flash memory, or holographic memory. In one embodiment, the memory 404 comprises a combination of random access memory and read only memory. In some embodiments, the processor 402 and memory 404 may be combined in a single chip. The network interface(s) 410, 412 allow the hoist assembly 104 to communicate with other devices via a computer network, (e.g., the Internet) or direct communication with such other devices, and may comprise a modulator/demodulator (MODEM). Memory 404 may store data processed in the method as well as the instructions for performing the exemplary method.

The processor 402 can be variously embodied, such as by a single core processor, a dual core processor (or more generally by a multiple core processor), a digital processor and cooperating math coprocessor, a digital controller, or the like. The processor 402, in addition to controlling the operation of the hoist assembly 104, executes instructions 408 stored in memory 404 for performing the method set forth hereinafter.

As shown in FIG. 6, the instructions 408 stored in memory 404 may include a pairing component 416, configured to facilitate pairing of the hoist assembly 104 with an external device, e.g., the remote control unit 106. In accordance with some aspects, the pairing component 322 may be configured to interact with the transceiver 314 to exchange a link key with the remote control unit 106, establishing bi-directional communication between the remote control unit 106 and the hoist assembly 104.

Turning now to FIG. 7, there is shown a flowchart 500 illustrating a method for detecting and preventing loss of a remote control unit 106 in accordance with some aspects disclosed and contemplated herein. The method 500 begins at step 502, whereupon a remote control unit 106 is paired with a hoist assembly 104. That is, at step 502, the remote control unit 106 and the hoist assembly 104 undergo a pairing procedure, linking the remote control unit 106 to the hoist assembly 104, enabling the hoist assembly 104 to receive commands from remote control unit 106. According to some aspects disclosed herein, the pairing occurring at step 502 is performed using a Bluetooth® protocol.

As used herein, the Bluetooth® protocol is a personal area network protocol designed to allow Bluetooth® equipped or enabled devices to communicate with each other within a confined area. In accordance with one example aspect disclosed and contemplated herein, during the pairing process, the remote control unit 106 and the hoist assembly 104 establish a shared secret, e.g., a link key. Subsequent to the pairing process, the remote control unit 106 and the hoist assembly 104 store the link key so that the pairing process is not required afterwards. Thereafter, as will be appreciated, the remote control unit 106 and the hoist assembly 104 can “bond” whenever they are close enough, e.g., the devices can automatically establish a connection whenever they are close enough. Pairing may also require an authentication process where a user must validate the connection between the two Bluetooth® devices.

Accordingly, the remote control unit 106 and the hoist assembly 104 each has a 6-byte device address called BD_ADDR (which stands for Bluetooth Device Address) that uniquely identifies the device. When the remote control unit 106 and the hoist assembly 104 are brought within wireless communication range, the two devices will exchange their BD_ADDR to see if they are already paired. If the BD_ADDR is recognized and a stored link key is available, the two devices can use the link key to bond, that is, they will re-establish the Bluetooth® communication channel without the need to go through the pairing process. According to some aspects contemplated herein, the pairing process between the remote control unit 106 and the hoist assembly 104 may require a technician to facilitate the pairing. Such an aspect, as will be appreciated, may function to prevent accidental de-pairing of the remote control unit 106 from the specific hoist assembly 104 through caretaker or subject error. The aforementioned pairing process may be implemented using Bluetooth® Low Energy (BLE) technology. According to such an implementation, BLE provides for lower power consumption, allowing for continuous communication between paired devices with reduced power consumption.

Returning to FIG. 7, after pairing, the retry counter component 328 sets the retry counter to zero. That is, no retries have been attempted to reconnect with the hoist assembly 104 at step 504. In accordance with some aspects, the retry counter component 328 stored in memory 304 of the remote control unit 106 may begin monitoring retry attempts after pairing, so as to begin the process of maintaining proximity of the remote control unit 106 with the hoist assembly 104 and avoiding loss of the remote control unit 106 used for controlling the hoist assembly 104.

At step 506, the timing component 324 or other suitable component associated with the remote control unit 106 initiates a check timer. As noted above, the check timer corresponds to a period before a connection request is sent to the paired hoist assembly 104. That is, the timing component 324 waits a predetermined period of time (e.g., a check time) before sending a connection request. In accordance with some aspects, this check time may correspond to a preselected period of time, e.g., every 5 seconds, every 10 seconds, every 15 seconds, 30 seconds, and so forth. A determination is then made at step 508 whether the check timer has expired, e.g., lapsed.

Upon a determination at step 508 that the check timer has not yet expired, operations return to waiting for the period to lapse. When it is determined at step 508 that the check timer has expired, operations proceed to step 510, whereupon a connection request is communicated from the remote control unit 106 to the hoist assembly 104. That is, at step 510, a communication is transmitted via the transceiver 314 of the remote control unit 106 to the transceiver 414 of hoist assembly 104 requesting the establishment of a bi-directional communication connection.

At step 512, the timing component 324 or other suitable component of the remote control unit 106 the initiates the connection timer. In accordance with some aspects, the connection timer may have a preselected duration during which the remote control unit 106 sends connection requests to the paired hoist assembly 104. For example, the connection timer may be set to a preselected period of time, e.g., every 100 milliseconds, every 200 milliseconds, every 300 milliseconds, 500 milliseconds, or other suitable period of time. A determination is then made at step 514 by the connection determination component 326 whether the remote control unit 106 has connected with the hoist assembly 104.

When it is determined at step 514 that a connection is established with the hoist assembly 104, operations proceed to step 516, whereupon the connection timer is stopped or paused. Any alarms/alerts that may be currently active on the remote control unit 106 are then terminated at step 518. Operations then proceed to step 520, whereupon the remote control unit 106 disconnects from the hoist assembly 104 and operations return to step 504, thereafter operations proceed as described above.

Upon a determination at step 514 by the connection determination component 326 that a connection has not been established, e.g., the remote control unit 106 is not connected to the hoist assembly 104, operations progress to step 522. The inability to establish a connection may be caused by a variety of problems, including, for example, the remote control unit 106 may have been moved a distance away from the hoist assembly 104 that exceeds the distance afforded by the communications protocol used, e.g., for Bluetooth® Low Energy protocols, the distance generally is less than 10 meters, e.g., the outside of the room in which the hoist assembly 104 to which the remote control unit 106 is paired.

At step 522, a determination is made whether the connection timer has expired. When it is determined that the connection timer has not expired, operations return to step 514 to determine whether a connection has been established. If no connection has yet been established, the determination is made at step 522 whether the connection timer has expired. Upon a determination at step 522 that the connection timer has expired, the retry counter is incremented by one attempt at step 524. As noted above, the remote control unit 106 may be configured with a retry counter component 328 that maintains a count of the number of connection attempts performed by the remote control unit 106 to establish a connection with the hoist assembly 104. After incrementing the retry counter at step 524, a determination is made at step 526 whether the retry counter has exceeded the preset number of connection attempts.

Upon a determination that the retry counter has not yet met the preset limit at step 526, flow returns to step 506 whereupon operations of the remote control unit 106 proceed as discussed above. When it is determined that the retry counter has met the preset limit, e.g., five or more unsuccessful attempts have been made, ten or more unsuccessful attempts have been made, etc., operations proceed to step 528, whereupon the alert/alarm component 330 activates one or more of an audible and/or visible alerts. That is, the alert/alarm component 330 may be configured to activate the indicator 103, the speaker 316, and/or the vibrator 318 indicating that a connection has been lost or cannot be established. Stated another way, the alert/alarm component 330 determines that the remote control unit 106 is outside a predetermined range relative to hoist assembly 104, and activates one or more of the aforementioned notification components.

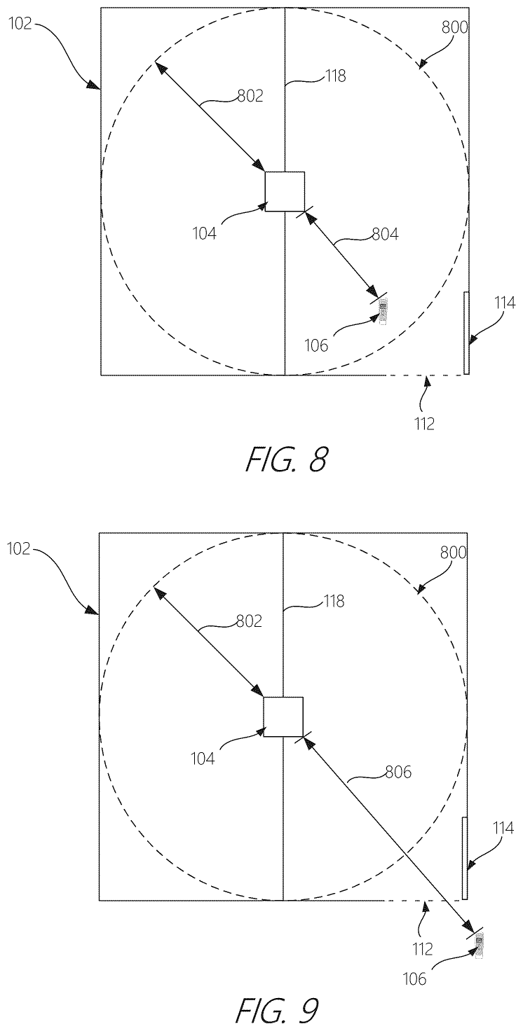

Turning now to FIGS. 8 and 9, there are shown diagrams depicting application of the systems and methods described in detail above. As shown in FIG. 8, there is shown a top view of the room 102 in which the hoist assembly 104 and paired remote control unit 106 are located. As shown in FIG. 8, the communications protocol used by the transceiver 414 of the hoist assembly 104 and the transceiver 314 of the remote control unit 106 has a preset coverage area 800, shown by the dashed lines within the room 102. In accordance with some aspects, the coverage area 800 shown in FIG. 8 may have a defined radius 802 corresponding to a set distance away from the hoist assembly 104 from which the remote control unit 106 will still have connectivity. Stated another way, while the remote control unit 106 remains within the coverage area 800, e.g., within the same room 102 in which the hoist assembly 104 is positioned, no alert/alarm will be needed, as described above with respect to steps 502-520 of FIG. 7. However, when the remote control unit 106 is moved outside the room 102, as shown in FIG. 9, the process described above with respect to steps 502 through 528 of FIG. 7.

Referring now to FIG. 9, there is shown a top view of the room 102 in which the hoist assembly 104 is located and after the remote control unit 106 has been removed from the room 102. As shown in FIG. 9, the remote control unit 106 is outside the preset coverage area 800 of the communications protocol used by the transceiver 414 of the hoist assembly 104 and the transceiver 314 of the remote control unit 106. As shown in FIG. 9, the distance 806 of the remote control unit 106 is greater than the defined radius 802 corresponding to the set distance away from the hoist assembly 104 from which the remote control unit 106 will still have connectivity. Stated another way, while the remote control unit 106 remains outside the coverage area 800, e.g., outside the room 102 in which the hoist assembly 104 is positioned, the remote control unit 106 generates an alert/alarm, as described above with respect to steps 502-528 of FIG. 7.

Using FIGS. 8-9, when a caregiver is present in the room 102 and using the remote control unit 106 to control the hoist assembly 104, the remote control unit 106 is connected to the hoist assembly 104 and thus the check timer and connection timers are satisfied. Accordingly, no alert/alarm is generated by the remote control unit. However, when the caregiver removes the remote control unit 106 from the room 102, e.g., leaves the remote control unit 106 in a lab coat pocket and walks out the entranceway 112. As shown in FIG. 9, the remote control unit 106 is now a second distance 806 away from the hoist assembly 104, the remote control unit 106, once the check timer has lapsed, sends a connection request to the hoist assembly 104, as discussed above with respect to FIG. 7 above.

Further aspects of the present disclosure described herein are provided by the subject matter of the following clauses:

A wirelessly controllable hoist system is disclosed. The wirelessly controllable hoist system includes a hoist assembly that includes a hoist wireless transceiver configured for personal area network communications. The system further includes a remote control unit that is operable to control the hoist assembly. The remote control unit includes a remote wireless transceiver that is configured to communicate with the hoist wireless transceiver of the hoist assembly via a personal area network. The remote control unit further includes one or more of an audio, a haptic, or a visual indication component that is affixed to a housing of the remote control unit, and which are configured to generate a respective audible or visible alarm. The remote control unit further includes a processor that is in communication with the remote wireless transceiver and memory storing instructions which are executed by the processor to perform at least one connection attempt to establish bi-directional communication with the hoist assembly, and in response to a failed connection attempt, generate the alarm via the at least one of the audio, the haptic, or the visual indication component.

The wirelessly controllable hoist system according to any of the preceding clauses, wherein the remote wireless transceiver and the hoist wireless transceiver are at least one of a Bluetooth transceiver, a Zigbee transceiver, or a near-field communication transceiver.

The wirelessly controllable hoist system according to any of the preceding clauses, wherein the at least one of the audio, the haptic, or the visual indication component is selected from a group consisting of an indicator light, a speaker, and a vibrator.

The wirelessly controllable hoist system according to any of the preceding clauses, further comprising instructions to initiate a connection timer corresponding to a time period during which a connection attempt is made.

The wirelessly controllable hoist system according to any of the preceding clauses, further comprising instructions to sending the connection attempt subsequent to the initiation of the connection timer.

The wirelessly controllable hoist system according to any of the preceding clauses, further comprising instructions to increment a retry counter corresponding to a number of failed connection attempts in response to a failure to connection during the time period of the connection timer.

The wirelessly controllable hoist system according to any of the preceding clauses, further comprising instructions to generate the alarm in response to the retry counter exceeding a retry limit.

The wirelessly controllable hoist system according to any of the preceding clauses, further comprising instructions to stop the alarm in response to a successful connection attempt.

The wirelessly controllable hoist system according to any of the preceding clauses, wherein the time period is selected from a group consisting of less than or equal to 100 milliseconds, less than or equal to 200 milliseconds, less than or equal to 300 milliseconds, or less than or equal to 500 milliseconds.

The wirelessly controllable hoist system according to any of the preceding clauses, wherein the retry limit is selected from a group consisting of 5 failed connection attempts, 10 failed connection attempts, 15 failed connections attempts, or 20 failed connection attempts.

The wirelessly controllable hoist system according to any of the preceding clauses, further comprising instructions to initiate a check timer corresponding to a check time period to occur before a connection request is attempted.

The wirelessly controllable hoist system according to any of the preceding clauses, wherein the connection timer is initiated in response to the check timer having met or exceeded the check time period.

The wirelessly controllable hoist system according to any of the preceding clauses, wherein the check time period is selected from the group consisting of less than or equal to 5 seconds, less than or equal to 10 seconds, less than or equal to 15 seconds, or less than or equal to 20 seconds.

A remote control unit of a hoist system is disclosed. The remote control unit includes a remote wireless transceiver that is configured for communication with a wireless transceiver of an associated hoist assembly via a personal area network. The remote control unit also includes one or more of an audio, a haptic, or a visual indication component that are affixed to a housing of the remote control unit, and which are operable to generate a respective audible or visible alarm. The remote control unit further includes a processor that is in communication with the remote wireless transceiver and memory storing instructions which are executed by the processor to initiate a connection timer corresponding to a time period during which a connection attempt is made, and perform at least one connection attempt to establish bi-directional communication with the hoist assembly during the time period. The instructions stored in memory also are executed by the processor to, in response to a preset number of failed connection attempts, generate the alarm via the audio, the haptic, and/or the visual indication component.

The remote control unit according to any of the preceding clauses, wherein the hoist system is an overhead hoist system.

The remote control unit according to any of the preceding clauses, wherein the remote wireless transceiver is at least one of a Bluetooth transceiver, a Zigbee transceiver, or a near-field communication transceiver.

The remote control unit according to any of the preceding clauses, wherein the at least one of the audio, the haptic, or the visual indication component is selected from a group consisting of an indicator light, a speaker, and a vibrator.

The remote control unit according to any of the preceding clauses, further comprising instructions to increment a retry counter corresponding to the preset number of failed connection attempts in response to a failure to connection during the time period of the connection timer.

The remote control unit according to any of the preceding clauses, further comprising instructions to generate the alarm in response to the retry counter exceeding a retry limit.

The remote control unit according to any of the preceding clauses, further comprising instructions to stop the alarm in response to a successful connection attempt.

The remote control unit according to any of the preceding clauses, wherein the time period is selected from the group consisting of less than or equal to 100 milliseconds, less than or equal to 200 milliseconds, less than or equal to 300 milliseconds, or less than or equal to 500 milliseconds.

The remote control unit according to any of the preceding clauses, wherein the retry limit is selected from the group consisting of 5 failed connection attempts, 10 failed connection attempts, 15 failed connections attempts, or 20 failed connection attempts.

The remote control unit according to any of the preceding clauses, further comprising instructions to initiate a check timer corresponding to a check time period to occur before a connection request is attempted.

The remote control unit according to any of the preceding clauses, wherein the connection timer is initiated in response to the check timer having met or exceeded the check time period.

The remote control unit according to any of the preceding clauses, wherein the check time period is selected from the group consisting of less than or equal to 5 seconds, less than or equal to 10 seconds, less than or equal to 15 seconds, or less than or equal to 20 seconds.

A remote control unit of a hoist system is disclosed. The remote control unit includes a remote wireless transceiver that is configured for communication with a wireless transceiver of an associated hoist assembly via a personal area network. The remote control unit also includes one or more of an audio, a haptic, or a visual indication component that is affixed to a housing of the remote control unit, and which are operable to generate a respective audible or visible alarm. The remote control unit further includes a processor in communication with the remote wireless transceiver and memory storing instructions which are executed by the processor to initiate a connection timer corresponding to a time period during which a connection attempt is made, and perform the connection attempt to establish bi-directional communication with the hoist assembly during the time period. The remote control unit also includes instructions to increment a retry counter in response to a failed connection attempt occurring during the time period, and to compare the incremented retry counter to a retry limit of failed connection attempts. Additionally, the remote control unit includes instructions to generate the alarm via the at least one of the audio, the haptic, or the visual indication component in response to a result of the comparison meeting the retry limit of failed connection attempts.

The remote control unit according to any of the preceding clauses, wherein the remote wireless transceiver is at least one of a Bluetooth transceiver, a Zigbee transceiver, or a near-field communication transceiver.

The remote control unit according to any of the preceding clauses, wherein the hoist system is an overhead hoist system.

The remote control unit according to any of the preceding clauses, wherein the at least one of the audio, the haptic, or the visual indication component is selected from a group consisting of an indicator light, a speaker, and a vibrator.

The remote control unit according to any of the preceding clauses, wherein the time period is selected from the group consisting of less than or equal to 100 milliseconds, less than or equal to 200 milliseconds, less than or equal to 300 milliseconds, or less than or equal to 500 milliseconds.

The remote control unit according to any of the preceding clauses, wherein the retry limit is selected from the group consisting of 5 failed connection attempts, 10 failed connection attempts, 15 failed connections attempts, or 20 failed connection attempts.

The remote control unit according to any of the preceding clauses, further comprising instructions to initiate a check timer corresponding to a check time period to occur before a connection request is attempted.

The remote control unit according to any of the preceding clauses, wherein the connection timer is initiated in response to the check timer having met or exceeded the check time period.

The remote control unit according to any of the preceding clauses, wherein the check time period is selected from the group consisting of less than or equal to 5 seconds, less than or equal to 10 seconds, less than or equal to 15 seconds, or less than or equal to 20 seconds.

The remote control unit according to any of the preceding clauses, further comprising instructions to stop the alarm in response to a successful connection attempt.

The remote control unit according to any of the preceding clauses, further comprising instructions to stop the connection timer in response to a successful connection attempt.

The remote control unit according to any of the preceding clauses, further comprising instructions to reset the retry counter in response to a successful connection attempt.

According to at least one aspect of the present disclosure, a wirelessly controllable hoist system is disclosed. The system includes a hoist assembly that includes a hoist wireless transceiver configured for personal area network communications. The system also includes a remote control unit operable to wirelessly control the hoist assembly. The remote control unit includes a remote wireless transceiver configured for communication with the hoist wireless transceiver of the hoist assembly via a personal area network, and one or more of an audio, a haptic, or a visual indication component affixed to a housing of the remote control unit. The audio, haptic, or visual indication component are operable to generate a respective audible or visible alarm. The remote control unit also includes a processor in communication with the remote wireless transceiver and memory storing instructions which are executed by the processor to initiate a check timer corresponding to a check time period to occur before a connection request is attempted, and to initiate, in response to the check timer having met or exceeded the check time period, a connection timer corresponding to a time period during which the connection attempt is made. The remote control unit also includes instructions to perform the connection attempt to establish bi-directional communication with the hoist assembly during the time period, and increment a retry counter in response to a failed connection attempt occurring during the time period. The remote control unit further includes instructions to compare the incremented retry counter to a retry limit of failed connection attempts, and to generate the alarm via the at least one of the audio, the haptic, or the visual indication component in response to a result of the comparison meeting the retry limit of failed connection attempts

The wirelessly controllable hoist system according to any of the preceding clauses, wherein the time period is selected from the group consisting of less than or equal to 100 milliseconds, less than or equal to 200 milliseconds, less than or equal to 300 milliseconds, or less than or equal to 500 milliseconds.

The wirelessly controllable hoist system according to any of the preceding clauses, wherein the retry limit is selected from the group consisting of 5 failed connection attempts, 10 failed connection attempts, 15 failed connections attempts, or 20 failed connection attempts.

The wirelessly controllable hoist system according to any of the preceding clauses, wherein the check time period is selected from the group consisting of less than or equal to 5 seconds, less than or equal to 10 seconds, less than or equal to 15 seconds, or less than or equal to 20 seconds.

The wirelessly controllable hoist system according to any of the preceding clauses, further comprising instructions to stop the alarm in response to a successful connection attempt.

The wirelessly controllable hoist system according to any of the preceding clauses, further comprising instructions to stop the connection timer in response to a successful connection attempt.

The wirelessly controllable hoist system according to any of the preceding clauses, further comprising instructions to reset the retry counter in response to a successful connection attempt.

A remote control unit of a hoist system is disclosed. The remote control unit includes a remote wireless transceiver that is configured for communication with a wireless transceiver of an associated hoist assembly. The remote control unit also includes one or more of an audio, a haptic, or a visual indication component that are affixed to a housing of the remote control unit, and which are operable to generate a respective audible or visible alarm. The remote control unit further includes a processor that is in communication with the remote wireless transceiver and memory storing instructions which are executed by the processor to perform at least one connection attempt to establish bi-directional communication with the hoist assembly during the time period. The instructions stored in memory also are executed by the processor to, in response to a preset number of failed connection attempts, generate the alarm via the audio, the haptic, and/or the visual indication component.

The remote control unit according to any of the preceding clauses, wherein the hoist system is an overhead hoist system.

The remote control unit according to any of the preceding clauses, wherein the remote wireless transceiver is at least one of a Bluetooth transceiver, a Zigbee transceiver, or a near-field communication transceiver.

The remote control unit according to any of the preceding clauses, wherein the at least one of the audio, the haptic, or the visual indication component is selected from a group consisting of an indicator light, a speaker, and a vibrator.

The remote control unit according to any of the preceding clauses, further comprising instructions to increment a retry counter corresponding to the preset number of failed connection attempts in response to a failure to connect.

The remote control unit according to any of the preceding clauses, further comprising instructions to generate the alarm in response to the retry counter exceeding a retry limit.

The remote control unit according to any of the preceding clauses, further comprising instructions to stop the alarm in response to a successful connection attempt.

The remote control unit according to any of the preceding clauses, wherein the retry limit is selected from the group consisting of 5 failed connection attempts, 10 failed connection attempts, 15 failed connections attempts, or 20 failed connection attempts.

The remote control unit according to any of the preceding clauses, further comprising instructions to initiate a check timer corresponding to a check time period to occur before a connection request is attempted.

The remote control unit according to any of the preceding clauses, wherein a connection timer is initiated in response to the check timer having met or exceeded the check time period.

The remote control unit according to any of the preceding clauses, wherein the check time period is selected from the group consisting of less than or equal to 5 seconds, less than or equal to 10 seconds, less than or equal to 15 seconds, or less than or equal to 20 seconds.

The remote control unit according to any of the preceding clauses, wherein the connection timer is initiated corresponding to a time period during which a connection attempt is made, and wherein the at least one connection attempt to establish bi-directional communication with the hoist assembly is performed during the time period.

The remote control unit according to any of the preceding clauses, wherein the time period is selected from the group consisting of less than or equal to 100 milliseconds, less than or equal to 200 milliseconds, less than or equal to 300 milliseconds, or less than or equal to 500 milliseconds.

It will now be understood that the disclosure provides various solutions for utilizing a remote control unit for wirelessly controlling a hoist system, including preventing the loss of the remote control unit. The described solutions provide a wirelessly controllable hoist system that includes a remote control unit equipped with a wireless transceiver that periodically attempts to connect with a wireless transceiver incorporated into the hoist system. In various instances, preset timers, connection attempts, and the like, are used by the remote control unit to determine when the remote control unit is out of range of the hoist system. When such an event occurs, the remote control unit is configured to emit audio, haptic (tactile), and/or visual alerts indicating the location of the remote control unit and prompting the return thereof to proximity to the hoist system.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular aspects have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A wirelessly controllable hoist system, comprising:
a hoist assembly comprising a hoist wireless transceiver configured for personal area network communications; and
a remote control unit operable to wirelessly control the hoist assembly, comprising:
a remote wireless transceiver configured for communication with the hoist wireless transceiver of the hoist assembly via a personal area network,
at least one of an audio, a haptic, or a visual indication component affixed to a housing of the remote control unit, operable to generate a respective audible or visible alarm, and
a processor in communication with the remote wireless transceiver and memory storing instructions which are executed by the processor to:
perform at least one connection attempt to establish bi-directional communication with the hoist assembly, and
in response to a failed connection attempt, generate the alarm via the at least one of the audio, the haptic, or the visual indication component.

2. The wirelessly controllable hoist system of claim 1, wherein the wirelessly controllable hoist system is an overhead hoist system.

3. The wirelessly controllable hoist system of claim 1, wherein the remote wireless transceiver and the hoist wireless transceiver are at least one of a Bluetooth transceiver, a Zigbee transceiver, or a near-field communication transceiver.

4. The wirelessly controllable hoist system of claim 1, wherein the at least one of the audio, the haptic, or the visual indication component is selected from a group consisting of an indicator light, a speaker, and a vibrator.

5. The wirelessly controllable hoist system of claim 1, further comprising instructions to initiate a connection timer corresponding to a time period during which a connection attempt is made.

6. The wirelessly controllable hoist system of claim 5, further comprising instructions to sending the connection attempt subsequent to the initiation of the connection timer.

7. The wirelessly controllable hoist system of claim 6, further comprising instructions to increment a retry counter corresponding to a number of failed connection attempts in response to a failure to connection during the time period of the connection timer.

8. The wirelessly controllable hoist system of claim 7, further comprising instructions to generate the alarm in response to the retry counter exceeding a retry limit.

9. The wirelessly controllable hoist system of claim 8, further comprising instructions to stop the alarm in response to a successful connection attempt.

10. The wirelessly controllable hoist system of claim 9, wherein the time period is selected from a group consisting of less than or equal to 100 milliseconds, less than or equal to 200 milliseconds, less than or equal to 300 milliseconds, or less than or equal to 500 milliseconds.

11. The wirelessly controllable hoist system of claim 9, wherein the retry limit is selected from a group consisting of 5 failed connection attempts, 10 failed connection attempts, 15 failed connections attempts, or 20 failed connection attempts.

12. The wirelessly controllable hoist system of claim 6, further comprising instructions to initiate a check timer corresponding to a check time period to occur before a connection request is attempted.

13. The wirelessly controllable hoist system of claim 12, wherein the connection timer is initiated in response to the check timer having met or exceeded the check time period.

14. The wirelessly controllable hoist system of claim 13, wherein the check time period is selected from the group consisting of less than or equal to 5 seconds, less than or equal to 10 seconds, less than or equal to 15 seconds, or less than or equal to 20 seconds.

15. A remote control unit of a hoist system, comprising:
a remote wireless transceiver configured for communication with a wireless transceiver of an associated hoist assembly via a personal area network;
at least one of an audio, a haptic, or a visual indication component affixed to a housing of the remote control unit, operable to generate a respective audible or visible alarm; and
a processor in communication with the remote wireless transceiver and memory storing instructions which are executed by the processor to:
initiate a connection timer corresponding to a time period during which a connection attempt is made,
perform at least one connection attempt to establish bi-directional communication with the hoist assembly during the time period, and
in response to a preset number of failed connection attempts, generate the alarm via the at least one of the audio, the haptic, or the visual indication component.

16. The remote control unit of claim 15, wherein the hoist system is an overhead hoist system.

17. The remote control unit of claim 16, wherein the remote wireless transceiver is at least one of a Bluetooth transceiver, a Zigbee transceiver, or a near-field communication transceiver.

18. The remote control unit of claim 17, wherein the at least one of the audio, the haptic, or the visual indication component is selected from a group consisting of an indicator light, a speaker, and a vibrator.

19. The remote control unit of claim 15, further comprising instructions to increment a retry counter corresponding to the preset number of failed connection attempts in response to a failure to connection during the time period of the connection timer.

20. The remote control unit of claim 19, further comprising instructions to generate the alarm in response to the retry counter exceeding a retry limit.
